(19) United States
(12) Patent Application Publication
(10) Pub. No.: US 2010/0315374 A1
(43) Pub. Date: Dec. 16, 2010

(54) DISPLAY DEVICE AND METHOD OF APPLYING THE SAME

(75) Inventors: Tzu-Jung Chen, Hsin-Chu City (TW); Po-Yuan Liu, Hsin-Chu City (TW); Min-Feng Chiang, Hsin-Chu City (TW); Ming-Sheng Lai, Hsin-Chu City (TW)

Correspondence Address: AUSTIN RAPP & HARDMAN, 170 South Main Street, Suite 735, SALT LAKE CITY, UT, 84101, US

(73) Assignee: AU Optronics Corp., Hsin-Chu (TW)

(21) Appl. No.: 12/764,095

(22) Filed: Apr. 21, 2010

(30) Foreign Application Priority Data
Jun. 15, 2009 (TW) 098119951

(51) Int. Cl. G06F 3/045

(52) U.S. Cl. 345/174

(57) ABSTRACT

A display device and a method of applying the same are introduced herein. A shielding layer is utilized to interpose between a transparent conductive layer of a touch element and a common electrode layer of a liquid crystal display (LCD) panel. With controlling variances of a first and a second control signals, a coupling current between the transparent conductive layer and common electrode layer can approach none, whereby influences of capacitive coupling effect between the common electrode layer or shielding layer and the transparent conductive layer of the touch element can be reduced. Thus, high touch accuracy of the touch element can be achieved and the noise can be eliminated simultaneously.

### CLAIM OF PRIORITY

This application claims priority to Taiwanese Patent Application No. 098119951 filed on Jun. 15, 2009.

### BACKGROUND OF THE INVENTION

1. Field of the Invention The present invention relates to a display device and method of applying the same, and more particularly, to a display device and method of applying the same that can reduce the effect of capacitive coupling and influence of noise.

2. Description of the Prior Art

Nowadays, touch screens have developed many types, such as resistive, capacitive, optical, acoustic, electromagnetic, and image sensor types. Touch screens induce an input signal through direct touch with a part of the human body such as a finger or with an exclusive stylus. However, the plurality of touch screens can be primarily classified into add-on and embedded types based on the position of sensing circuits in touch screens or differences in fabrication sequences.

A so-called add-on touch screen is that the external surface of the display device thereof such as liquid crystal display (LCD) panels is additionally laminated with a transparent touch panel (TP) with sensing circuits, such as a capacitive touch panel. The surface of a transparent substrate (e.g., glass) of the plurality of capacitive touch panels is plated with a layer of indium tin oxide (ITO) and a hard coater in sequence. Between the ITO layer of the TP and the LCD panel, a shielding layer of protecting electrical signals is disposed.

As for an embedded touch screen mentioned previously, a transparent TP with sensing circuits is fabricated directly inside a LCD panel. Because the TP is directly fabricated in an LCD panel of the touch screen, a single ITO layer is merely required in most cases. Comparing with an add-on touch screen, an embedded touch screen has slimmer total thickness of the panel thereof and maintains a higher degree of light transmittance.

FIG. 1A shows a cross-section view of an embedded touch screen 1 in the prior art, mainly comprising an embedded touch panel 2, such as a surface capacitive or a projected capacitive touch panel, and an LCD panel 4. The embedded touch panel 2 thereinto is embedded on the upper surface of the LCD panel 4. The LCD panel 4 mainly comprises a first substrate 16 with a colored filter 18, a common electrode layer 20, which is formed below the colored filter 18, a second substrate 26, and a liquid crystal layer 24, which is formed between the first substrate 16 and second substrate 26. The embedded touch panel 2 mainly comprises a polarizer film (PF) 10, a conductive layer 12, which is situated below the PF 10 and above the first substrate 16, and a patterned electrode 14, which is formed at the periphery of the conductive layer 12. Because the first conductive layer 12 is an ITO layer used to store electric charge and is installed with capacitive sensing circuits, it seems as though the first conductive layer 12 forms a high-density touch sensing electrode. But, because capacitive sensing circuits are easy to be affected by some noise produced by TFT-LCDs per se, surrounding environments, etc. to be distorted, resulting in incorrect response. For example, when the capacitive touch panel is actuated though the driving voltage signal of the LCD panel 4 has not been turned on yet, predetermined normal aligned lines will be demonstrated as shown on the left side of FIG. 1C via the embedded touch panel 2. However, once the capacitive touch panel is actuated and the driving voltage signal of the LCD panel 4 is turned on, the plurality of lines will become jittering due to serious noise interference as shown on the right side of FIG. 1C via the embedded touch panel 2.

As FIGS. 1A and 1B show, when a human finger 5 touches the embedded touch panel 2, a finger sensing capacitor Cf is naturally formed between the finger 5 and the first conductive layer 12, which receives alternating current (AC). And static electricity in the human body flows to the ground to induce comparatively a slight sensing current I_{f} to charge the sensing capacitor Cf and to flow to the finger 5. Depending on variation in current of the sensing current I_{f}, a touch point coordinate of the finger 5 on the embedded touch panel 2 can be detected.

Please further refer to FIGS. 1A and 1B. In general, the common electrode layer 20 of the LCD panel 4 receives direct current (DC) of about 3V to 5V as a control signal to activate the LCD panel 4, so a huge coupling capacitance C will be naturally formed between the conductive layer 12 of the embedded touch panel 2 and the common electrode layer 20 of the LCD panel 4. The coupling capacitance C is much huger than the capacitance of the above-mentioned finger sensing capacitor Cf, so the sensing current I_{f} flowing through the sensing capacitor Cf is very tiny, which further affects sensing intensity of the embedded touch panel 2. In this way, the sensitivity will worsen when the finger 5 touches the embedded touch panel 2, which makes it more difficult in sensing correctly or sensing positions.

### SUMMARY OF THE INVENTION

One objects of the present invention is to provide a display device and method of applying the same. The display device is equipped with an additional shielding layer, which is interposed between the transparent conductive layer of the touch panel (TP) and the common electrode layer of the liquid crystal display panel (LCD panel). By controlling a first control signal and a second control signal, the effect of capacitive coupling on touch sensing of the TP can be reduced so that the touch sensitivity of the TP can be enhanced.

Another object of the present invention is to provide a display device and method of applying the same. The display device is equipped with an additional shielding layer, which is interposed between the transparent conductive layer of the TP and the common electrode layer of the LCD panel, to block out surrounding noise or noise produced by the LCD per se.

According to the present invention, a display device comprises a liquid crystal display panel and a touch panel thereon. The touch panel comprises a first conductive layer for receiving a first control signal, a contact layer on the first conductive layer for being touched by an object, a patterned electrode around the first conductive layer for delivering a corresponding sensing signal as soon as the contact layer is touched by the object, and a second conductive layer disposed between the contact layer of the touch panel and the liquid crystal display panel, or disposed within the liquid crystal display panel, for receiving a second control signal to enhance the sensing signal.

In one aspect of the present invention, the second control signal and the first control signal are synchronous.

In another aspect of the present invention, the first control signal and the second control signal are different, and the second control signal is floating.

Also, the present invention further provides a method of applying the display device. The method comprises the following steps:
making the transparent conductive layer receive the first control signal and form a first capacitance in response to a human contact on the transparent conductive layer, and
making patterned electrode transmit a sensing signal to the first capacitance based on the human contact,
making the shielding layer receive the second control signal to mask noise of the TP to prevent the sensing signal from being affected, and forming a second capacitance between the shielding layer and the transparent conductive layer, so that a coupling signal flows through the second capacitance; and
controlling the first control signal and the second control signal to synchronize the first and second control signals or to make the first and second control signals having the same voltage level, or to make the first and second control signals have different voltage levels while the second control signal becomes floating, so as to lower the coupling signal to enhance the touch sensitivity of the sensing signal.

Therefore, in the present invention, by controlling the first and second control signals, the coupling signal formed between the transparent conductive layer and shielding layer can be extremely close to zero. Thus, the possibility that the effect of either capacitive coupling of the shielding layer or the common electrode layer on the transparent conductive layer affects the sensing of the TP is reduced. In consequence, the touch sensitivity of the TP is enhanced.

These and other objects of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A shows a cross-section view of a conventional embedded touch screen.

FIG. 1B shows a human finger touching the embedded touch panel.

FIG. 1C illustrates a plurality of lines become jittering due to serious noise interference via the embedded touch panel.

FIG. 2A shows a cross-section view of an embedded touch screen according to a first preferred embodiment of the present invention.

FIG. 2B shows an equivalent circuit diagram of a display device of FIG. 2A.

FIG. 3A shows a cross-section view of an embedded touch screen according to a second preferred embodiment of the present invention.

FIG. 3B shows an equivalent circuit diagram of a display device of FIG. 3A.

FIG. 4A shows a cross-section view of an embedded touch screen according to a third preferred embodiment of the present invention.

FIG. 4B shows an equivalent circuit diagram of a display device of FIG. 4A.

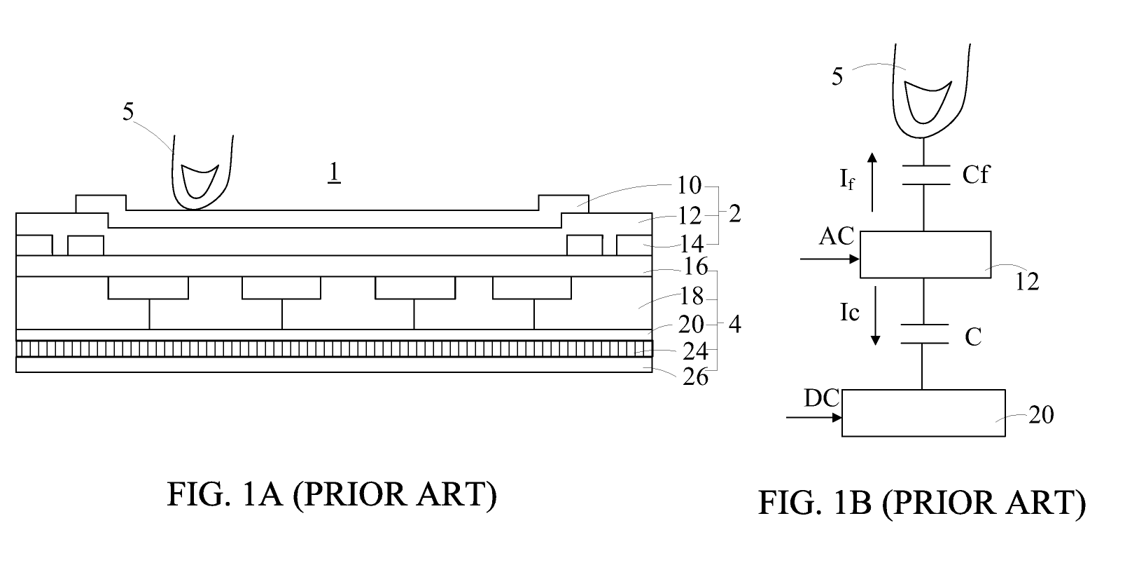

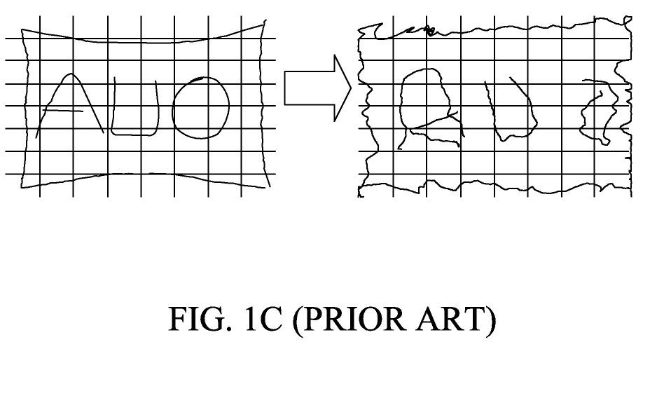

### DETAILED DESCRIPTION OF THE PREFERRED EMBODIMENT

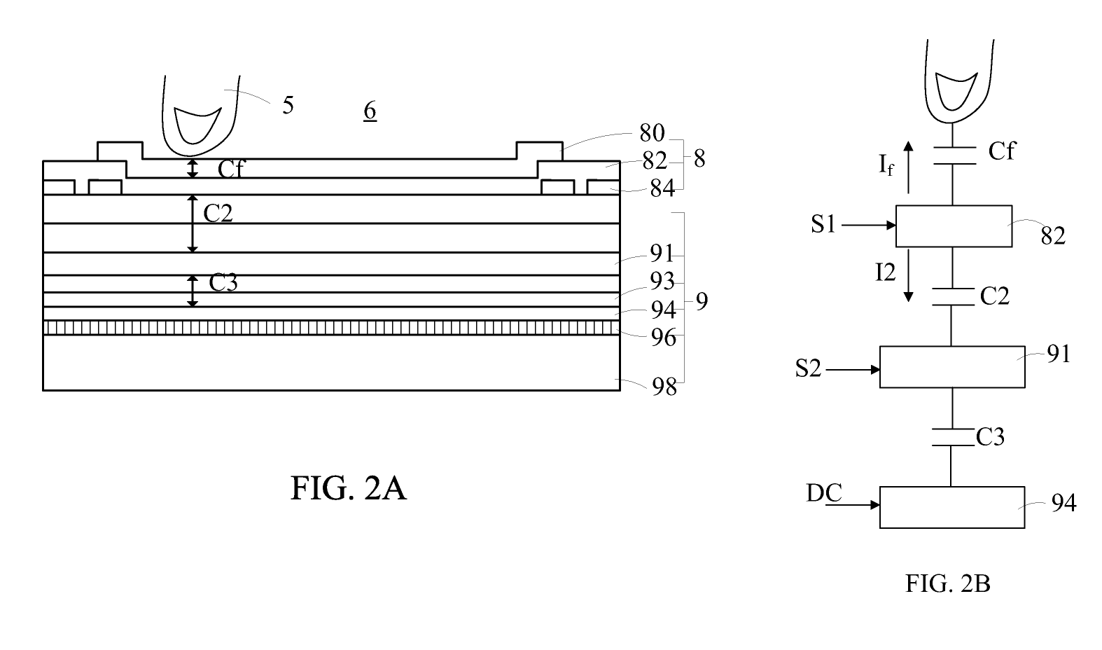

Please refer to FIGS. 2A and 2B, first. Both of the figures show a display device 6 of a first preferred embodiment of the present invention. The display device 6 mainly comprises a touch panel (TP) 8, a LCD panel 9, and at least one shielding layer 91. In the present embodiment, the TP 8, which can be either a surface capacitive touch panel, a projected capacitive touch panel, or other touch panels with similar technology, is embedded (e.g., film formation) on the upper surface of the LCD panel 9. The TP 8 comprises a polarized light contact layer 80 situated at the outermost layer position (e.g., a polarizer film (PF), which can act as a hard coater (HC) layer as well), which allows a part of the human body such as the finger 5 to touch directly, a transparent conductive layer 82 (e.g., ITO, which is situated beneath the polarized light contact layer 80 and receives a first control signal S1), and a plurality of patterned-electrode layer 84 comprised by conductive electrodes, which are disposed at the periphery of the transparent conductive layer 82 and electrically connected with the transparent conductive layer 82. The patterned-electrode layer 84 transmit the first control signal S1 and form an electric field on the transparent conductive layer 82 to detect an induced signal induced by static electricity in the human body such as the current value of the induced current I_{f}.

The LCD panel 9 such as a TFT-LCD comprises a first substrate (not shown), a color filter 93, a common electrode layer 94, which is disposed beneath the color filter 93 and receives a DC driving control signal so as to display the LCD panel 9, a second substrate 98 such as a TFT Array substrate, and a liquid crystal layer 96, which is formed between the first and second substrates.

The shielding layer 91, such as an additional ITO conduction layer, is placed between the transparent conductive layer 82 of the TP 8 and the common electrode layer 94 of the LCD panel 9 to receive a second control signal S2 to mask external noise received by the TP 8 or noise produced by the LCD panel 9.

When the finger 5 does not touch the exterior surface of the polarized light contact layer 80 of the TP 8, the patterned-electrode layer 84 practically transmit the first control signal S1 (e.g., alternating current (AC)) to the transparent conductive layer 82 to form a uniform electric field with the same electric potential. Thus, no induced current will flow through the TP 8. As FIGS. 2A and 2B show, once the finger 5 touches the polarized light contact layer 80 of the TP 8, an induction capacitor Cf will be formed naturally between the finger 5 and the transparent conductive layer 82 (roughly the same position as the polarized light contact layer 80), which receives the first control signal S1, because the human body is a good conductor; that is, the finger 5 and the transparent conductive layer 82 act as both ends of the induction capacitor Cf. Meanwhile, static electricity in the human body produced by the finger 5 which touches the polarized light contact layer 80 of the TP 8 seems to form an external touch signal flowing to the ground and changing the previously mentioned electric field. The patterned-electrode layer 84 transmit a feeble induced current I_{f}, which charges the induction capacitor Cf and flows to the finger 5 via the transmittance of the transparent conductive layer 82. With help of the production of the current value of the induced current I_{f}, a touch point coordinate of the finger 5 on the TP 8 can be detected.

Similarly, under the effect of capacitive coupling, a coupling capacitance C2 is naturally formed between the transparent conductive layer 82 of the TP 8, which receives the first control signal S1, and the shielding layer 91, which receives the second control signal S2, and an induced current I2 is formed as well, flowing to the shielding layer 91 via the coupling capacitance C2. In addition, a coupling capacitance C3 is naturally formed between the common electrode layer 94, which receives a DC driving control signal, and the shielding layer 91, which receives the second control signal S2, and an induced current is formed as well, flowing through the coupling capacitance C3. By controlling level variations of the first control signal S1 and second control signal S2, the current value of the induced current I2 can be changed, and even the current value of the induced current I2 can be controlled to become extremely close to zero to impede current conduction between the transparent conductive layer 82 and the shielding layer 91. Thus, the induced current I2 is not able to charge the coupling capacitance C2, which prevents the effect of capacitive coupling formed between either the common electrode layer 94 or the shielding layer 91 and the transparent conductive layer 82 from affecting the induction of the TP 8; that is, in order to avoid the induced current I2 from affecting the induced current L the current value of the induced current I2 (e.g., The induced current I_{f} is larger than the induced current I2.) is lowered to enhance the touch sensitivity of the TP 8.

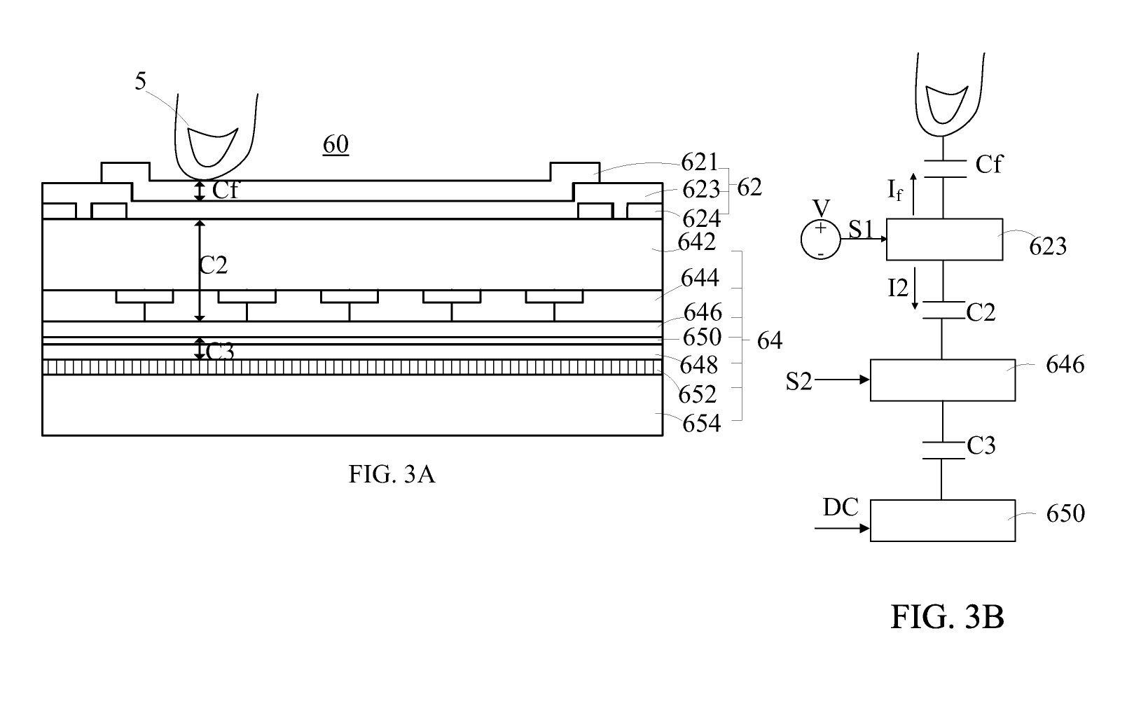

Please also refer to FIGS. 3A and 3B, which show a display device 60 of a second preferred embodiment of the present invention. The display device 60 mainly comprises a TP 62 and a LCD panel 64. The TP 62 similarly comprises a contact layer 621, a transparent conductive layer 623 (e.g., ITO thin films receive a first control signal S1), and patterned-electrode layer 624, which are disposed at the periphery of the transparent conductive layer 623 and electrically connected with the transparent conductive layer 623.

The LCD panel 64 such as a TFT-LCD comprises a first substrate 642, a color filter 644, a shielding layer 646 (e.g., ITO layer), which is placed beneath the color filter 644 and receives a second control signal S2 to mask external noise of the TP 62 or noise produced by the LCD panel 64, a common electrode layer 648, which receives a DC driving control signal to enable the LCD panel 64, an insulating layer 650 (e.g., overcoat (OC) layer), which is disposed between the shielding layer 646 and common electrode layer 648 to provide electrical insulation, a second substrate 654 (e.g., TFT Array substrate), and a liquid crystal layer 652, which is formed between the first and second substrates, 642 and 654.

Similarly, as shown in FIG. 3A and FIG. 3B, when the finger 5 touches the TP 62, an induction capacitor Cf is naturally formed between the finger 5 and the transparent conductive layer 623, which receives the first control signal S1 (roughly in the position of the contact layer 621); meanwhile, static electricity in the human body seems to form an external touch signal to make the patterned-electrode layer 624 transmit a feeble induced current I_{f}, which charges the induction capacitor Cf and flows to the finger 5 via the conduction of the transparent conductive layer 623.

Although a coupling capacitance C2 is naturally formed between the transparent conductive layer 623, which receives the first control signal S1, and the shielding layer 646, which receives the second control signal S2, and an induced current I2 is formed, flowing to the shielding layer 646 via the coupling capacitance C2, and although a coupling capacitance C3 is naturally formed between the common electrode layer 648, which receives a DC driving control signal, and the shielding layer 646, which receives the second control signal S2, and an induced current is formed, flowing through the coupling capacitance C3, the first control signal S1 is arranged as an AC signal, and the second control signal S2 as a floating signal; that is, there is no signal sources connected. In this way, the current conduction between the transparent conductive layer 623 and the shielding layer 646 can be impeded so that the current value of the induced current I2 can be controlled to be reduced to be close to zero; that is, by reducing the current value of the induced current I2 (e.g., The induced current I_{f} is larger than the induced current I2), the induced current I2 is prevented from affecting the induced current I_{f} to enhance the touch sensitivity of the TP 62.

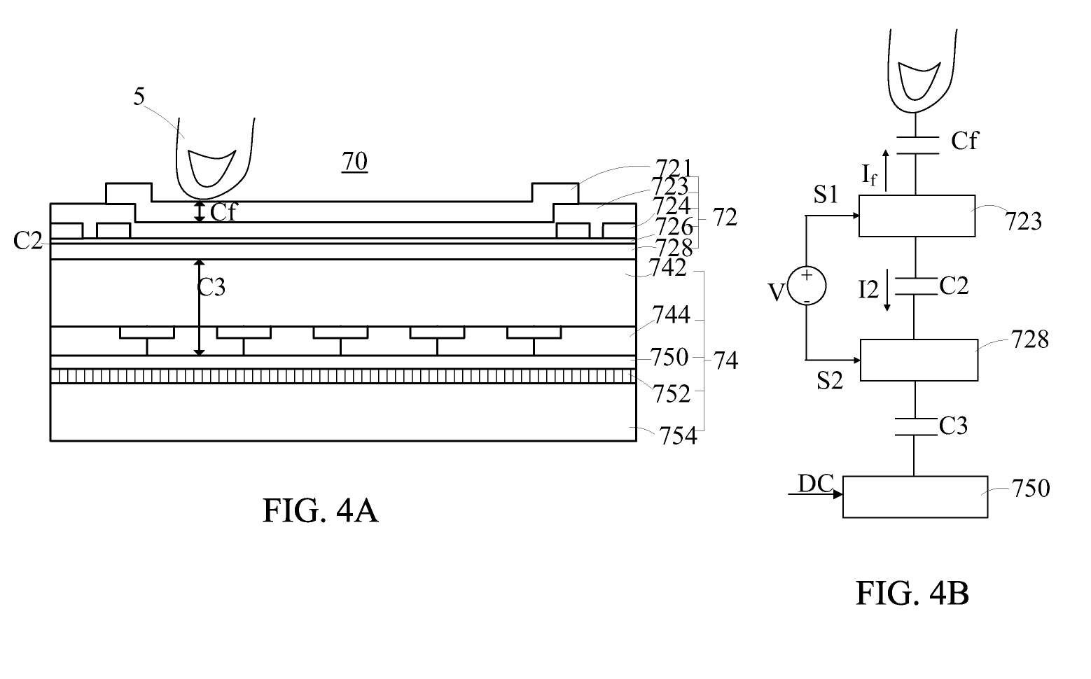

Please also refer to FIGS. 4A and 4B, which show a display device 70 of a third preferred embodiment of the present invention. The display device 70 mainly comprises a TP 72 and a LCD panel 74. Differing from the second embodiment, the TP 72 of the third embodiment comprises a contact layer 721, a transparent conductive layer 723 (e.g., ITO thin films receive a first control signal S1), a shielding layer 728 (e.g., ITO layer), which receives a second control signal S2 to mask external noise of the TP 72 or noise produced by the LCD panel 74, an insulating layer 726 (e.g., overcoat (OC) layer), which is disposed between the shielding layer 728 and transparent conductive layer 723 to provide electrical insulation, and a patterned-electrodes layer 724 for transmitting induced current I_{f}, which are placed at the periphery of the transparent conductive layer 723 and electrically connected with the transparent conductive layer 723.

The LCD panel 74 such as a TFT-LCD comprises a first substrate 742, a color filter 744, a common electrode layer 750, which is placed beneath the color filter 744 and receives a DC driving control signal so as to display the LCD panel 74, a second substrate 754 (e.g., TFT Array substrate), and a liquid crystal layer 752, which is formed between the first and second substrates, 742 and 754.

As shown in FIG. 4A and FIG. 4B, when the finger 5 touches the TP 72, an induction capacitor Cf is naturally formed between the finger 5 and the transparent conductive layer 723, which receives the first control signal S1. Meanwhile, static electricity in the human body from the finger 5 seems to form an external touch signal to make the patterned-electrode layer 724 transmit a feeble induced current I_{f}, which charges the induction capacitor Cf and flows to the finger 5 via the conduction of the transparent conductive layer 723. A coupling capacitance C2 is naturally formed between the transparent conductive layer 723, which receives the first control signal S1, and the shielding layer 728, which receives the second control signal S2. Besides, a coupling capacitance C3 is naturally formed as well between the common electrode layer 750, which receives the DC driving control signal, and the shielding layer 728, which receives the second control signal S2. By connecting the first control signal S1 and the second control signal S2 to the same AC voltage source or by adding an OP amplifier shunt circuit to split current, the first and second control signals can be controlled to have the same or synchronous electric potential in order to reduce the current value of the induced current I2 between the transparent conductive layer 723 and the shielding layer 728 to be close to zero so that the current conduction between the transparent conductive layer 723 and the shielding layer 728 is impeded and unable to charge the coupling capacitance C2. In this way, the effect of capacitive coupling produced by either the common electrode layer 750 or the shielding layer 728 and the transparent conductive layer 723 is prevented from affecting the induction of the electric field of the TP 72; that is, by lowering the current value of the induced current I2 (e.g., The induced current I_{f} is larger than the induced current I2), the induced current I2 is prevented from affecting the induced current I_{f} in order to enhance the touch sensitivity of the TP 72.

In addition, one preferred embodiment of the present invention further provides a method of applying the display device. The method has the following steps (Please refer to FIG. 4A as well):
providing a LCD panel which comprises a common electrode layer, and providing a TP embedded on the LCD panel comprising a touch layer, a transparent conductive layer, patterned-electrode layer disposed at the periphery of the transparent conductive layer and electrically connected with the transparent conductive layer, a shielding layer, and an insulating layer disposed between the transparent conductive layer and shielding layer;
making the transparent conductive layer receive a first control signal, forming a first capacitance in the contact layer between the transparent conductive layer and shielding layer, and making patterned-electrode layer correspondingly produce a first induction signal, which flows to the first capacitance via the transparent conductive layer, based on static electricity, which seems to form an external touch signal when the human body touches the contact layer.
making the shielding layer receive a second control signal to mask noise received by the TP, forming a second capacitance between the shielding layer and transparent conductive layer, and making a second induction signal flow through the second capacitance; and
controlling the variations of the first and second control signals (e.g., level), for example, to make the first and second control signals have the same or synchronous electric potential so as to control the second induction signal to be smaller than the first induction signal or even to be close to zero.

In addition, another preferred embodiment of the present invention further provides a method of applying the display device. The method has the following steps (Please refer to FIG. 3A as well):
providing a LCD panel which comprises at least a common electrode layer, a shielding layer, and an insulating layer disposed between the common electrode layer and shielding layer, providing a TP embedded on the LCD panel with a contact layer, a transparent conductive layer, and patterned-electrode layer situated beneath the transparent conductive layer and contact layer;
making the transparent conductive layer receive a first control signal, forming a first capacitance between the transparent conductive layer and shielding layer, and making the patterned-electrode layer correspondingly produce a first induction signal which flows to the first capacitance via the transparent conductive layer based on static electricity, which seems to form an external touch signal when the human body touches the contact layer;
making the shielding layer receive a second control signal to mask noise received by the TP, forming a second capacitance, and making a second induction signal flow through the second capacitance; and
controlling the variations of the first and second control signals to make the first and second control signals different and the second control signal as a floating signal so as to control the second induction signal to be smaller than the first induction signal, or even to be close to zero.

According to the above-mentioned embodiments, the present invention provides a display device and method of applying the same. The methods are that an additional shielding layer is inserted into the transparent conductive layer of the TP and the common electrode layer of the LCD panel, and that the level variations of the first and second control signals are controlled to make the induction current between the shielding layer and the transparent conductive layer of the TP be reduced to be close to zero in order to lower the possibility that the effect of capacitive coupling produced by either the shielding layer or the common electrode layer on the transparent conductive layer affects the induction of the electrical field of the TP; that is, by avoiding the induced current I_{f} touched by the finger from being affected, the touch sensitivity of the TP can be thus enhanced. Meanwhile, the shielding layer can mask noise from the LCD panel as well to further reduce the effect of the noise.

The present invention has been described with reference to certain preferred and alternative embodiments which are intended to be exemplary only and not limited to the full scope of the present invention as set forth in the appended claims.

What is claimed is:

1. A display device comprising:
a touch element comprising a first conductive layer to receive a first control signal, to form a first capacitor in response to a contact on the first conductive layer, and to generate a sensing signal corresponding to the first capacitor; and
a second conductive layer for receiving a second control signal to enhance the sensing signal.

2. The display device as claimed in claim 1, wherein the second control signal and the first control signal are synchronous.

3. The display device as claimed in claim 1, wherein the touch element further comprises a contact layer to form the first capacitor when being touched.

4. The display device as claimed in claim 3, wherein the contact layer is a polarizer film to be touched by an object.

5. The display device as claimed in claim 3, wherein the first conductive layer comprises peripheral patterned electrode for delivering the sensing signal as soon as the first capacitor is formed.

6. The display device as claimed in claim 1, wherein a second capacitor is formed between the first conductive layer and the second conductive layer and a coupling current flows through the second capacitor, when the second conductive layer receives the second control signal as wells as the first conductive layer receives the first control signal, in which the coupling current is close to zero to suppress a capacitive coupling effect between the first conductive layer and the second conductive layer.

7. The display device as claimed in claim 1, further comprising a liquid crystal display panel with a third conductive layer which provides a common electrode to receive a third control signal, and to form a third capacitor between the second conductive layer and the third conductive layer.

8. The display device as claimed in claim 7, wherein the first control signal and the second control signal are synchronous, but not synchronous with the third control signal.

9. The display device as claimed in claim 7, wherein the second conductive layer is disposed within the touch element, and an insulating layer is disposed between the first conductive layer and the second conductive layer.

10. The display device as claimed in claim 7, wherein the first control signal, the second control signal and the third control signal are different, and the second control signal is floating.

11. The display device as claimed in claim 7, wherein the liquid crystal display panel further comprises a color filter, the second conductive layer is disposed between the color filter and the third conductive layer.

12. The display device as claimed in claim 11, wherein an insulating layer is disposed between the second conductive layer and the third conductive layer.

13. A method of applying the display device, the display device comprising a first conductive layer and a second conductive layer, the method comprising:
making the first conductive layer to receive a first control signal, forming a first capacitor in response to a contact on the first conductive layer, and generating a sensing signal corresponding to the first capacitor;
making the second conductive layer to receive a second control signal, forming a second capacitor between the first conductive layer and the second conductive layer, and generating a coupling signal, wherein the coupling signal is reduced by controlling the second control signal and the first control signal.

14. The method as claimed in claim 13, wherein the display device further comprises a liquid crystal display panel and a touch element on a surface of the liquid crystal display panel.

15. The method as claimed in claim 14, wherein the touch element further comprises a contact layer to form the first capacitor when being touched, and the first conductive layer is disposed within the touch element.

16. The method as claimed in claim 15, further comprising: forming the first capacitor with the contact layer, and delivering the sensing signal by using patterned electrode around the first conductive layer.

17. The method as claimed in claim 13, further comprising: controlling variations of the first control signal and the second control signal to make the sensing signal greater than the coupling signal.

18. The method as claimed in claim 13, further comprising: synchronizing the first control signal and the second control signal.

19. The method as claimed in claim 14, wherein the second conductive layer is disposed within the touch element, and an insulating layer is disposed between the first conductive layer and the second conductive layer.

20. The method as claimed in claim 13, further comprising: controlling the first control signal and the second control signal to be different, wherein the second control signal is floating.

21. The method as claimed in claim 14, wherein the second conductive layer is disposed within the liquid crystal display panel.

22. A display device comprising:
a liquid crystal display panel with a touch element thereon;
the touch element comprising:
a first conductive layer for receiving a first control signal;
a contact layer on the first conductive layer for being touched by an object;
a patterned electrode around the first conductive layer for delivering a corresponding sensing signal as soon as the contact layer is touched by the object; and
a second conductive layer disposed between the contact layer of the touch element and the liquid crystal display panel, or disposed within the liquid crystal display panel, for receiving a second control signal to enhance the sensing signal.

23. The display device as claimed in claim 22, wherein a first capacitor is formed over the first conductive layer, and the sensing signal from patterned electrode flows through the first conductive layer to charge the first capacitor, when the contact layer is touched by the object.

24. The display device as claimed in claim 22, wherein the second control signal and the first control signal are synchronous.

25. The display device as claimed in claim 22, wherein the contact layer is a polarizer film to be touched by the object.

26. The display device as claimed in claim 22, wherein a second capacitor is formed between the first conductive layer and the second conductive layer and a coupling current flows through the second capacitor, when the second conductive layer receives the second control signal as wells as the first conductive layer receives the first control signal, in which the coupling current is close to zero to suppress a capacitive coupling effect between the first conductive layer and the second conductive layer.

27. The display device as claimed in claim 22, wherein the liquid crystal display panel further comprises a third conductive layer which provides a common electrode to receive a third control signal, and to form a third capacitor between the second conductive layer and the third conductive layer.

28. The display device as claimed in claim 27, wherein the first control signal and the second control signal are synchronous, but not synchronous with the third control signal.

29. The display device as claimed in claim 22, wherein the second conductive layer is disposed within the touch element, and an insulating layer is disposed between the first conductive layer and the second conductive layer.

30. The display device as claimed in claim 27, wherein the first control signal, the second control signal and the third control signal are different, and the second control signal is floating.

31. The display device as claimed in claim 27, wherein the liquid crystal display panel further comprises a color filter, the second conductive layer is disposed between the color filter and the third conductive layer.

32. The display device as claimed in claim 27, wherein an insulating layer is disposed between the second conductive layer and the third conductive layer.
